(19) United States
(12) Patent Application Publication
(10) Pub. No.: US 2006/0200828 A1
(43) Pub. Date: Sep. 7, 2006

(54) Network element management system and method

(76) Inventor: Yeon-Joo Na, Seoul (KR)

Correspondence Address: Robert E. Bushnell;Suite 300, 1522 K Street, N.W., Washington, DC, 20005-1202, US

(21) Appl. No.: 11/331,077

(22) Filed: Jan. 13, 2006

(30) Foreign Application Priority Data
Mar. 3, 2005 (KR) 2005-17873

(51) Int. Cl. G06F 15/173; G06F 9/46

(52) U.S. Cl. 719/313; 709/223

(57) ABSTRACT

A network element management system includes a unit having a processing thread. The processing thread is adapted to: forward a management message to a network element by including an ID identifying the processing thread in the management message upon reception of the management message for management of the network element from a client; and process a reply message in response to the management message from the network element in response to an occurrence of a predetermined event.

### CLAIM OF PRIORITY

This application makes reference to and claims all benefits accruing under 35 U.S.C. § 119 from an application for “NETWORK ELEMENT MANAGEMENT SYSTEM AND METHOD” earlier filed in the Korean Intellectual Property Office on 3 of Mar. 2005 and there duly assigned Serial No. 2005-0017873.

### BACKGROUND OF THE INVENTION

1. Field of the Invention

The present invention relates to network element management system and method. More particularly, the present invention relates to managing network elements using multi-threads.

2. Description of the Related Art

Due to the increase in users of high speed communication networks and in order to meet various demands from the users, modern communication networks have come to need development in communication technologies as well as various services accompanying a massive quantity of data transmission/reception.

In general, a network is constituted as a collection of various Network Elements (NEs). The NEs of the network can include various elements such as a router and a switch. The NEs can also include various elements of a mobile communication system such as a Base Station (BS), a Base Station Controller (BSC), a base station management system, a switching center system and home location registration system.

In order to effectively manage a network including various NEs, a need has arisen for an Element Management System (EMS) for managing NEs.

A network Element Management System (EMS) includes an EMS client and an EMS server. The EMS functions to enable an NE manager to manage NEs as well as provide the NE manager with resultant information based upon the NE management. The EMS server implements corresponding operations in response to management requests for the NEs by the EMS client. It can be understood that the EMS is operated based on a server-client system.

The NE is an individual communication system of a network to be managed by the EMS. In the communication system, for example, a plurality of switching centers, a plurality of Base Station Controllers (BSCs) and a plurality of base stations connected to the BSCs will constitute network elements of a corresponding network.

The EMS client is a client for managing NEs, and acts to control major functions of the EMS using a Graphic User Interface (GUI).

That is, the EMS client enables an NE manager to manage the NEs via the GUI, and to provide resultant information based upon NE management to the NE manager via the GUI.

The EMS server generates a client thread and an NE thread in response to a management request for the NE from the EMS client. The client and NE threads and can be generated simultaneously or sequentially. That is, the client thread can be generated prior to the NE thread and vice versa.

The client thread provides the NE thread with a management request for the NE via an Inter Process Communication (IPC) from the EMS client, and provides the EMS client with a reply from the NE that is sent from the NE thread via the IPC.

That is, in response to the management request for the NE from the EMS client, the client thread waits for a predetermined time period that is provided along with the management request, and provides the EMS client with the reply of the NE, which is sent from the NE thread via the IPC. In this case, the predetermined time period provided by the EMS client is a preset value, that is, a process time given to the NE with respect to the management request from the EMS client.

The client thread forwards a command from the EMS client to the NE thread, and waits for the predetermined time period. If a reply is forwarded from the NE thread within the predetermined time period, the client thread forwards the reply to the EMS client. If no reply is forwarded from the NE thread within the predetermined time period, the client thread forwards an error reply message to the EMS client. A synchronization protocol is used for above-described communication between the EMS client and the client thread.

The client thread forwards a management request for the NE from the EMS client to the NE thread via the IPC, and the NE thread forwards the management request to the NE. Then, the NE replies to the management request from the EMS client, and the NE thread forwards the reply to the client thread via the IPC. The management request forwarded from the NE thread to the NE and the reply forwarded from the NE to the NE thread occur separately. A protocol used in the communication between the NE thread and the NE as above is referred to as an asynchronous protocol.

A time that the reply to the management request of the NE arrives at the EMS server can be varied according to a time needed for the NE to process the management request and a time that the reply arrives at the EMS server as a processing result in response to the management request from the NE. The time for the NE to process the management request can be estimated, but the time for the reply as a processing result in response to the management request from the NE to arrive the EMS server can be varied according to the network status of the network connecting the EMS server to the NE. Accordingly, there is a problem in that it is impossible to correctly calculate the wait time to receive the reply from the NE in response to the management request from the EMS client.

In addition, a specific time period for the client thread to wait for the reply from the NE in response to the NE management request from the EMS client is determined in advance. Accordingly, this causes a problem in that even though the reply from the NE arrives earlier than this specific time period, the reply from the NE is forwarded to the EMS client after this specific time period.

Methods for realizing communication between the client thread and the NE thread via the IPC can include shared memory and message queue techniques. However, due to the drawbacks of these techniques, it is difficult to realize the IPC for communication between the client thread and the NE thread. That is, the IPC becomes complicated to support communication of the client thread that uses a synchronous protocol with the NE thread that uses an asynchronous protocol.

### SUMMARY OF THE INVENTION

The present invention has been made to solve the foregoing problems and it is therefore an object of the present invention to provide network Element Management System (EMS) and method to manage network elements using multi-threads.

According to one aspect of the invention for realizing the above objects, a network element management system there is provided comprising a unit having a processing thread, wherein the processing thread is adapted to: forward a management message to a network element by including an ID identifying the processing thread in the management message upon reception of the management message for management of the network element from a client; and process a reply message in response to the management message from the network element in response to an occurrence of a predetermined event.

The management message preferably includes a preset time that the management message is to be processed by the network element, and wherein the reply message includes an ID for identifying the processing thread.

The predetermined event preferably comprises one of a no-reply event and a reply event, wherein the no-reply event occurs upon the reply message in response to the management message not being received from the network element during the preset time, and wherein the reply event occurs upon the reply message in response to the management message being received from the network element during the preset time.

The unit preferably includes: a memory thread adapted to store one of an ID of at least one processing thread and a type of at least one management message forwarded to the network element, upon the processing thread having failed to receive the reply message in response to the management message from the network element during the preset time that the management message is to be processed by the network element; a reply thread adapted to determine whether or not the processing thread ID contained in the reply message provided from the network element has been stored in the memory thread, to discard the reply message forwarded by the network element upon the processing thread ID contained in the reply message being stored in the memory thread, and to forward the reply message forwarded by the network element to the processing thread upon the processing thread ID contained in the reply message not being stored in the memory thread; and a timeout thread adapted to be activated after the preset time that the management message is to be processed by the network element, and to notify the processing thread that the reply message has not been received from the network element during the preset time upon the reply message not being received from the network element during the preset time for the management message to be processed.

The processing thread is preferably adapted to: forward the reply message to the client upon the reply message in response to the management message being received from the network element during the preset time; and store one of the ID of the processing thread, which has failed to receive the reply message in response to the management message from the network element during the preset time, and a type of the management message forwarded to the network element in a memory thread upon the reply message in response to the management message not being received from the network element during the preset time.

According to another aspect of the invention for realizing the above objects, a network element management method is provided comprising: forwarding a management message to a network element by including an ID identifying a processing thread in the management message by the processing thread generated in response to reception of a management message for management of the network element from a client; and processing, by the processing thread, a reply message in response to the management message from the network element in response to a predetermined event being generated.

The management message preferably includes a preset time that the management message is to be processed by the network element, and wherein the reply message contains an ID for identifying the processing thread.

The predetermined event preferably comprises one of a no-reply event and a reply event, wherein the no-reply event occurs upon the reply message in response to the management message not being received from the network element during the preset time, and wherein the reply event occurs upon the reply message in response to the management message being received from the network element during the preset time.

The network element management method preferably further comprises: forwarding the reply message to the client, by the processing thread, upon the reply message in response to the management message being received from the network element during the preset time; and storing, by the processing thread, one of the ID of the processing thread, which has failed to receive the reply message in response to the management message from the network element during the preset time, and a type of the management message provided to the network element in a memory thread, upon the reply message in response to the management message not being received from the network element during the present time.

### BRIEF DESCRIPTION OF THE DRAWINGS

A more complete appreciation of the present invention, and many of the attendant advantages thereof, will be readily apparent as the present invention becomes better understood by reference the following detailed description when considered in conjunction with the accompanying drawings in which like reference symbols indicate the same or similar components, wherein:

FIG. 1 is a block diagram of a network Element Management System (EMS);

FIG. 2 is a block diagram of a network EMS according to an embodiment of the present invention; and

FIG. 3 is a flowchart of a network element management method according to an embodiment of the present invention.

### DETAILED DESCRIPTION OF THE INVENTION

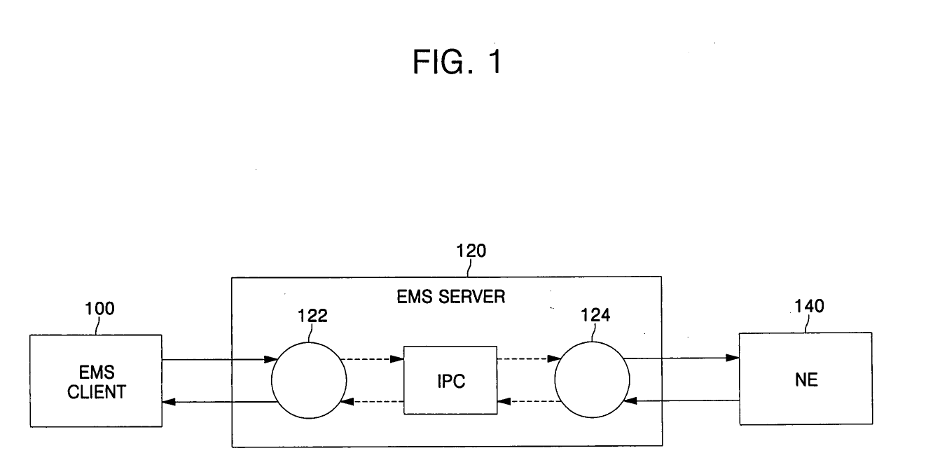

FIG. 1 is a block diagram of a network Element Management System (EMS). As shown in FIG. 1, the EMS includes an EMS client 100 and an EMS server 120. The EMS functions to enable an NE manager to manage NEs as well as provide the NE manager with resultant information based upon the NE management. The EMS server 120 implements corresponding operations in response to management requests for the NEs by the EMS client 100. It can be understood that the EMS is operated based on a server-client system. While more than one NE can exist, one NE 140 is illustrated for the sake of a simplified explanation.

The NE 140 is an individual communication system of a network to be managed by the EMS. In the communication system, for example, a plurality of switching centers, a plurality of Base Station Controllers (BSCs) and a plurality of base stations connected to the BSCs will constitute network elements of a corresponding network.

The EMS client 100 is a client for managing NEs, and acts to control major functions of the EMS using a Graphic User Interface (GUI).

That is, the EMS client 100 enables an NE manager to manage the NEs via the GUI, and to provide resultant information based upon NE management to the NE manager via the GUI.

The EMS server 120 generates a client thread 122 and an NE thread 124 in response to a management request for the NE 140 from the EMS client 100. The client and NE threads 122 and 124 can be generated simultaneously or sequentially. That is, the client thread 122 can be generated prior to the NE thread 124 and vice versa.

The client thread 122 provides the NE thread 124 with a management request for the NE 140 via an Inter Process Communication (IPC) from the EMS client 100, and provides the EMS client 100 with a reply from the NE 140 that is sent from the NE thread 124 via the IPC.

That is, in response to the management request for the NE 140 from the EMS client 100, the client thread 122 waits for a predetermined time period that is provided along with the management request, and provides the EMS client 100 with the reply of the NE 140, which is sent from the NE thread 124 via the IPC. In this case, the predetermined time period provided by the EMS client 100 is a preset value, that is, a process time given to the NE 140 with respect to the management request from the EMS client 100.

The client thread 122 forwards a command from the EMS client 100 to the NE thread 124, and waits for the predetermined time period. If a reply is forwarded from the NE thread 124 within the predetermined time period, the client thread 122 forwards the reply to the EMS client 100. If no reply is forwarded from the NE thread 124 within the predetermined time period, the client thread 122 forwards an error reply message to the EMS client 100. A synchronization protocol is used for above-described communication between the EMS client 100 and the client thread 122.

The client thread 122 forwards a management request for the NE 140 from the EMS client 100 to the NE thread 124 via the IPC, and the NE thread 124 forwards the management request to the NE 140. Then, the NE 140 replies to the management request from the EMS client 100, and the NE thread 124 forwards the reply to the client thread 122 via the IPC. The management request forwarded from the NE thread 124 to the NE 140 and the reply forwarded from the NE 140 to the NE thread 124 occur separately. A protocol used in the communication between the NE thread 124 and the NE 140 as above is referred to as an asynchronous protocol.

A time that the reply to the management request of the NE 140 arrives at the EMS server 120 can be varied according to a time needed for the NE 140 to process the management request and a time that the reply arrives at the EMS server 120 as a processing result in response to the management request from the NE 140. The time for the NE 140 to process the management request can be estimated, but the time for the reply as a processing result in response to the management request from the NE 140 to arrive the EMS server 120 can be varied according to the network status of the network connecting the EMS server 120 to the NE 140. Accordingly, there is a problem in that it is impossible to correctly calculate the wait time to receive the reply from the NE 140 in response to the management request from the EMS client 100.

In addition, a specific time period for the client thread 122 to wait for the reply from the NE 140 in response to the NE 140 management request from the EMS client 100 is determined in advance. Accordingly, this causes a problem in that even though the reply from the NE 140 arrives earlier than this specific time period, the reply from the NE 140 is forwarded to the EMS client 100 after this specific time period.

Methods for realizing communication between the client thread 122 and the NE thread 124 via the IPC can include shared memory and message queue techniques. However, due to the drawbacks of these techniques, it is difficult to realize the IPC for communication between the client thread 122 and the NE thread 124. That is, the IPC becomes complicated to support communication of the client thread 122 that uses a synchronous protocol with the NE thread 124 that uses an asynchronous protocol.

The following detailed description discusses a network Element Management System (EMS) and method in accordance with an embodiment of the present invention with reference to the accompanying drawings. The same reference symbols are used to designate the same or similar components throughout the different drawings, for the sake of understanding.

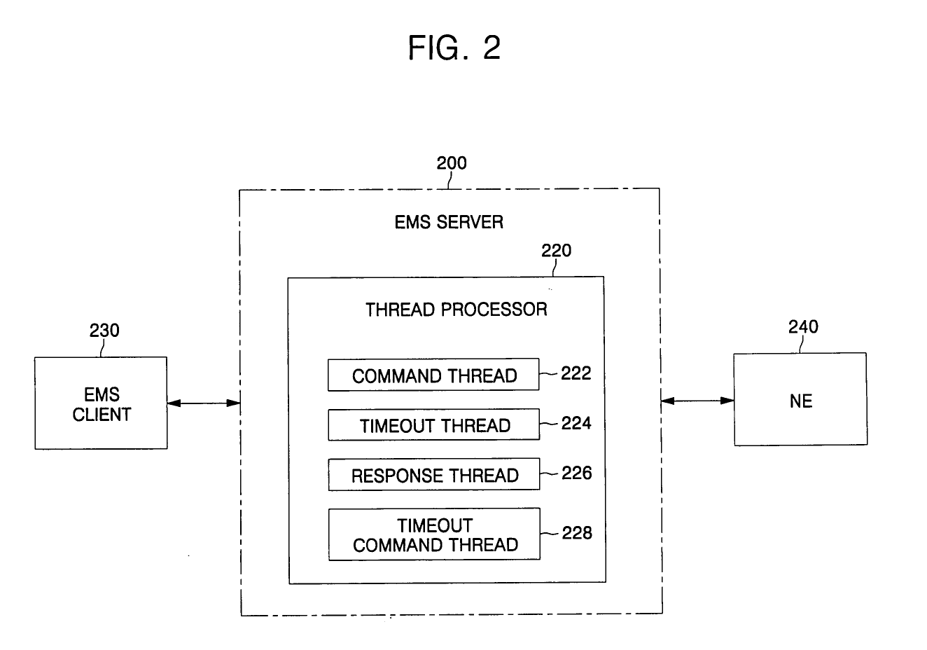

As shown in FIG. 2, a network Element Management System (EMS) in accordance with an embodiment of the invention includes an EMS server 200, an EMS client 230 and an NE 240.

The EMS client 230 provides the EMS server 200 with a management request for the NE 240 by including the management request in a management message. Herein a wait time contained in the management message is a time period that a reply in response to the management request for the NE 140 is to arrive at the EMS server 200. The wait time is preset by an NE manager in consideration of a time for processing the management request for the NE 140.

The EMS server 200 includes a thread processor 220. Upon receiving the management message for the management request for the NE 240 from the EMS client 230, the thread processor 220 allocates a command thread ID to generate a command thread 222. The management message forwarded by the EMS client 230 contains wait time information as to a time period that a reply in response to the management request for the NE 240 is to arrive at the EMS server 200. The wait time information is preset by the NE manager, in consideration of a time for the NE 240 to process the management message.

The command thread 222 forwards the the command thread ID to the NE 240, which is given to the command thread 222 by the thread processor 220, by including the command thread ID in the management message, generates a timeout thread 224, and provides the wait time from the EMS client 230 to the timeout thread 224. The command thread 222 then waits until a predetermined event takes place.

The timeout thread 224 waits for the wait time forwarded from the EMS client 230, and when it has been determined that the wait time has passed through elapsed time counting, converts into an active state. If a reply message in response to the management message is not received from the NE 240 during the wait time, the timeout thread 224 generates and forwards a non-reply event to the command thread 222.

Upon receiving a reply message, the thread processor 220 generates a reply thread 226 and forwards the ID of the command thread 222 and the reception time of the reply message to the generated reply thread. The reply thread forwarded by the NE 240 includes the ID of the command thread 222, and the reception time of the reply time indicates a difference between the time that the management message has been forwarded to the NE 240 and the time that the reply message has been received from the NE 240.

The reply thread determines whether or not the ID of the command thread 222 has been registered in a timeout command list 228. That is, the reply thread 226 determines whether or not the reply message has been received from the NE 240 after the wait time. If the ID of the command thread 222 has not been registered in the command list 228, that is, the reply message has been received from the NE 240 within the wait time, the reply thread 226 forwards the reply message from the NE 240 to the command thread 222. On the contrary, if the ID of the command thread 222 has been registered in the timeout command list 228, the reply thread 226 discards the reply message received from the NE 240. This is because the command ID can be repeatedly used, and if there is no information as to a management message having an expired wait time, a reply message for the management message of the expired wait time can be confused with that for a management message having a wait time that has not expired yet. In this way, it is possible to prevent reception of any reply message except for a normal reply message in response to the management message for the NE 240.

In the waiting status, if the predetermined event takes place, the command thread 222 determines whether or not the reply message from the NE 240 has been received after the wait time. The event can be of a no-reply event received from the timeout thread 224 or a reply message received from the reply thread. The reception time indicates a time difference between the time that the management message has been forwarded from the EMS server 200 to the NE 240 and the time that the EMS server 200 has received the reply message from the NE 240.

If the reception time of the reply message from the NE 240 exceeds the wait time, the command thread 222 forwards an error message to the EMS client 230. The command thread 222 also registers the type of management message forwarded to the NE 240 and the ID of a command thread for processing the management message in the timeout command list 228. That is, the command thread 222 registers the type of management message corresponding to the reply message, which has exceeded the wait time, and the ID of the command thread for processing the management message in the timeout command list 228.

If the reception time of the reply message from the NE 240 does not exceed the wait time, the command thread 222 terminates the timeout thread 224 and forwards the reply message from the NE 240 to the EMS client 230.

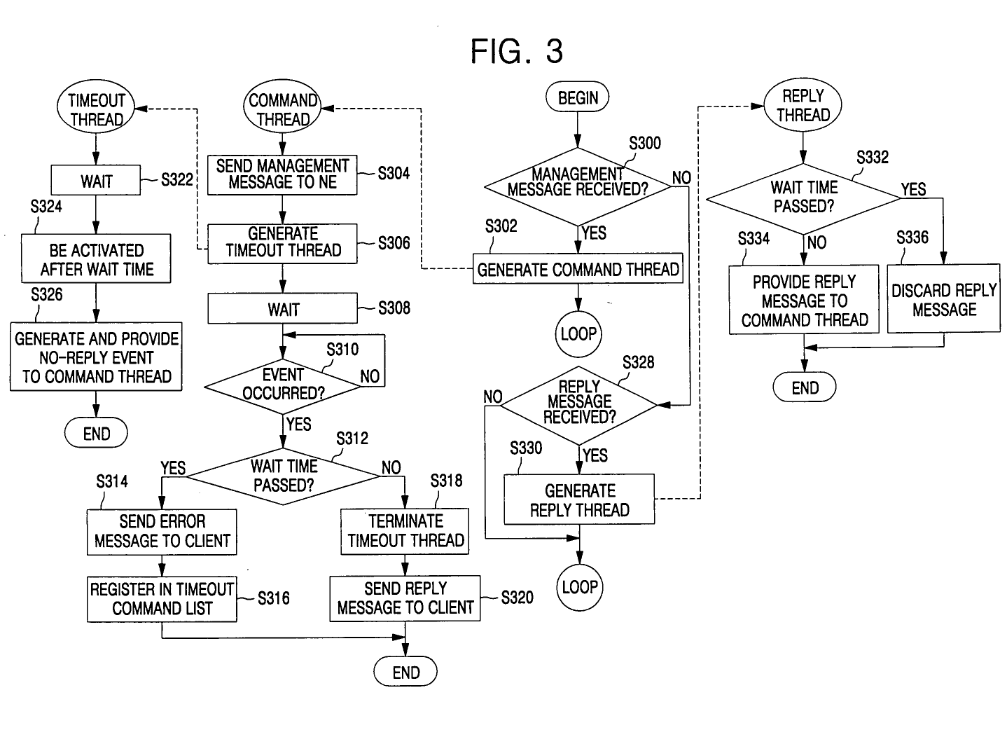

FIG. 3 is a flowchart of a network element management method according to an embodiment of the present invention.

As shown in FIG. 3, the thread processor 220 determines whether or not a management message for the management request of the NE 240 has been received from the EMS client 230 in S300. If the management message has been received, the thread processor 220 assigns a command thread ID to generate the command thread 222 in S302. The management message forwarded from the EMS client 230 contains wait time information indicating a time period that a reply to the management request is to arrive at the EMS server 200 from the NE 240. The wait time information has been previously set by the NE manager in consideration of a time period for the NE to process the management message.

The command thread 222 provides the NE 240 with the command thread ID assigned thereto by including the command thread ID in the management message in S304.

Then, the command thread 222 generates the timeout thread 224, and includes the wait time provided by the EMS client 230 in the timeout thread 224 in S306. In S308, the command thread 222 waits or stands by until a predetermined event takes place.

The timeout thread 224 waits during the wait time provided by the EMS client 230 in S322. The timeout thread 224 counts the wait time, and if the wait time has elapsed, converts into an active state in S324.

If a reply message to the management message has been received from the NE 240 during the wait time, the timeout thread 224 generates and forwards a no-reply event to the command thread 222 in S326.

If the management message has not been received from the EMS 230 in S300, the thread processor 220 determines whether or not a reply message to the management message has been received from the NE 240 in S328, and if the reply message has been received from the NE 240, generates the reply thread 226 and forwards the reply thread 226 with the ID of the command thread 222 and the reception time of the reply message. The reply message from the NE 240 contains the ID of the command thread 222, and the reception time of reply message indicates a difference between the time that the management message has been forwarded to the NE 240 and the time that the reply message has been received from the NE 240.

The reply thread 226 determines whether or not the ID of the command thread 222 has been registered in the timeout command list 228. That is, the reply thread 226 determines whether or not the reply message from the NE 240 has neen received after the wait time in S332.

If the ID of the command thread 222 has not been registered in the timeout command list 228, that is, if the reply message from the NE 240 has been received during the wait time, the reply thread 226 sends the reply message forwarded from the NE 240 to the command thread 222 in S334.

On the contrary, if the ID of the command thread 222 has been registered in the timeout command list 228, the reply thread 226 discards the reply message forwarded from the NE 240 in S336.

This is because the command ID can be repeatedly used, and if there is no information as to a management message having an expired wait time, a reply message for the management message of the expired wait time can be confused with that for a management message having a wait time that has not expired yet. In this way, it is possible to prevent reception of any reply message except for a normal reply message in response to the management message for the NE 240.

In the waiting status, the command thread 22 determines whether or not a predetermined event takes place in S310. If the predetermined event takes place, the command thread 222 determines whether or not the reply message from the NE 240 has been received after the wait time in S312. The event can be of a no-reply event received from the timeout thread 224 or a reply message received from the reply thread. The reception time indicates a time difference between the time that the management message has been forwarded from the EMS server 200 to the NE 240 and the time that the EMS server 200 has received the reply message from the NE 240.

If the reception time of the reply message from the NE 240 exceeds the wait time, the command thread 222 forwards an error message to the EMS client 230 in S314. In S316, the command thread 222 also registers the type of management message forwarded to the NE 240 and the ID of a command thread for processing the management message in the timeout command list 228. That is, the command thread 222 registers the type of management message corresponding to the reply message, which has exceeded the wait time, and the ID of the command thread for processing the management message in the timeout command list 228.

On the contrary, if the reception time of the reply message from the NE 240 does not exceed the wait time, the command thread 222 terminates the timeout thread 224 in S318, and forwards the reply message from the NE 240 to the EMS client 230 in S320.

While the present invention has been shown and described in connection with the an exemplary embodiment, it will be apparent to those skilled in the art that modifications and variations can be made without departing from the spirit and scope of the present invention as defined by the appended claims.

According to the network management system and method of the present invention as described hereinbefore, communication among an EMS client, an EMS server and a network element for management and operation of the network elements is established through multi-threads. It is therefore possible to forward a reply from the network elements to the EMS client irrespective of a preset time for management message processing by the network, and the EMS server can not use an IPC for communication between a client thread and the network element. What is claimed is:

1. A network element management system comprising a unit having a processing thread, wherein the processing thread is adapted to:
forward a management message to a network element by including an ID identifying the processing thread in the management message upon reception of the management message for management of the network element from a client; and
process a reply message in response to the management message from the network element in response to an occurrence of a predetermined event.

2. The network element management system according to claim 1, wherein the management message includes a preset time that the management message is to be processed by the network element, and wherein the reply message includes an ID for identifying the processing thread.

3. The network element management system according to claim 1, wherein the predetermined event comprises one of a no-reply event and a reply event, wherein the no-reply event occurs upon the reply message in response to the management message not being received from the network element during the preset time, and wherein the reply event occurs upon the reply message in response to the management message being received from the network element during the preset time.

4. The network element management system according to claim 1, wherein the unit includes:
a memory thread adapted to store one of an ID of at least one processing thread and a type of at least one management message forwarded to the network element, upon the processing thread having failed to receive the reply message in response to the management message from the network element during the preset time that the management message is to be processed by the network element;
a reply thread adapted to determine whether or not the processing thread ID contained in the reply message provided from the network element has been stored in the memory thread, to discard the reply message forwarded by the network element upon the processing thread ID contained in the reply message being stored in the memory thread, and to forward the reply message forwarded by the network element to the processing thread upon the processing thread ID contained in the reply message not being stored in the memory thread; and
a timeout thread adapted to be activated after the preset time that the management message is to be processed by the network element, and to notify the processing thread that the reply message has not been received from the network element during the preset time upon the reply message not being received from the network element during the preset time for the management message to be processed.

5. The network element management system according to claim 1, wherein the processing thread is adapted to:
forward the reply message to the client upon the reply message in response to the management message being received from the network element during the preset time; and
store one of the ID of the processing thread, which has failed to receive the reply message in response to the management message from the network element during the preset time, and a type of the management message forwarded to the network element in a memory thread upon the reply message in response to the management message not being received from the network element during the preset time.

6. A network element management method, comprising:
forwarding a management message to a network element by including an ID identifying a processing thread in the management message by the processing thread generated in response to reception of a management message for management of the network element from a client; and
processing, by the processing thread, a reply message in response to the management message from the network element in response to a predetermined event being generated.

7. The network element management method according to claim 6, wherein the management message includes a preset time that the management message is to be processed by the network element, and wherein the reply message contains an ID for identifying the processing thread.

8. The network element management method according to claim 6, wherein the predetermined event comprises one of a no-reply event and a reply event, wherein the no-reply event occurs upon the reply message in response to the management message not being received from the network element during the preset time, and wherein the reply event occurs upon the reply message in response to the management message being received from the network element during the preset time.

9. The network element management method according to claim 6, further comprising:
forwarding the reply message to the client, by the processing thread, upon the reply message in response to the management message being received from the network element during the preset time; and
storing, by the processing thread, one of the ID of the processing thread, which has failed to receive the reply message in response to the management message from the network element during the preset time, and a type of the management message provided to the network element in a memory thread, upon the reply message in response to the management message not being received from the network element during the present time.
